(19) United States
(12) Patent Application Publication
(10) Pub. No.: US 2011/0195218 A1
(43) Pub. Date: Aug. 11, 2011

(54) Insulating Panel

(75) Inventors: James Carolan, County Cavan (IE); Gregory Flynn, County Louth (IE)

(73) Assignee: Kingspan Research and Developments Limited

(21) Appl. No.: 12/923,173

(22) Filed: Sep. 7, 2010

Related U.S. Application Data
(63) Continuation of application No. 11/921,645, filed on Dec. 6, 2007, now abandoned.

(30) Foreign Application Priority Data
Jun. 13, 2005 (IE) 2005/0396

(51) Int. Cl. B32B 3/08; B32B 5/20; E04B 1/74; B29C 65/00

(52) U.S. Cl. 428/55; 428/69; 264/46.5

(57) ABSTRACT

An insulating panel comprises sheets (1, 2) with a body (3) of insulating foam between the sheets. The insulating material has a vacuum insulated panel (4) embedded therein. The panel is substantially thinner than corresponding panels without a vacuum insulated panel (4).

This application is a Continuation of application Ser. No. 11/921,645 filed Dec. 6, 2007, which is a national stage of International Application No. PCT/IE2006/000065 filed Jun. 13, 2006 and published in English.

### INTRODUCTION

The invention relates to an insulating body and in particular to an insulating panel of the type comprising a body of insulating foam material.

There is an increasing need to provide insulating panels with improved thermal performance in a cost efficient manner.

This invention is directed towards providing such an improved insulating panel.

### STATEMENTS OF INVENTION

According to the invention there is provided an insulating panel comprising an external facing, an internal facing, and a body of insulating material between the facings, wherein the insulating material has a vacuum insulated panel embedded therein.

In one embodiment the insulating material is a foam material.

In one case a plurality of vacuum insulated panels are embedded in the insulating foam.

At least some of the vacuum insulated panels are connected to one another.

In one embodiment the vacuum insulated panels extend longitudinally substantially the length of the insulated panel.

In one embodiment the vacuum insulated panels extend laterally substantially the width of the insulating panel.

The vacuum insulated panels may extend for at least 25%, at least 50%, at least 65% of the thickness of the insulating foam.

The inner facing may be of metal sheet.

The outer facing may be of metal sheet.

The outer and/or inner sheets may be profiled.

The invention also provides a method for manufacturing an insulating body comprising the steps of:—
leading a first substrate to a foam lay down station;
laying liquid foam reactants onto the first substrate;
applying a second substrate over the liquid foam reactants;
allowing the foam to expand to form an insulating body;
wherein before, after or during lay-down of liquid foam reactants a vacuum insulating panel is inserted.

In one embodiment the vacuum insulated panel is inserted after application of a first lay down. The first lay down may comprise a bonding material which is compatible with the liquid foam reactants. The first lay down may comprise liquid foam reactants.

In one embodiment a plurality of vacuum insulating panels are inserted.

The vacuum insulating panels may be interconnected and the method comprise inserting the interconnected panels.

In one embodiment the method comprises the steps of providing a plurality of interconnected vacuum panels and substantially continuously inserting the vacuum panels onto the first lay-down.

In one embodiment the vacuum panels are in a stack or are on a reel and the method comprises leading the vacuum panels from the stack or reel for insertion.

The first substrate may be of metal sheet, especially of profiled metal sheet. The second substrate may be of metal sheet.

The invention also provides a panel when manufactured by the method of the invention.

The invention also provides an insulating body comprising an insulating material such as an insulating foam, the insulating material having a vacuum insulated panel embedded therein.

### BRIEF DESCRIPTION OF THE DRAWINGS

The invention will be more clearly understood from the following description thereof given by way of example only, with reference to the accompanying drawings in which:—

FIG. 1 is a perspective, partially cross sectional view of an insulating panel according to the invention;

FIG. 2 is a cross sectional view of the panel of FIG. 1;

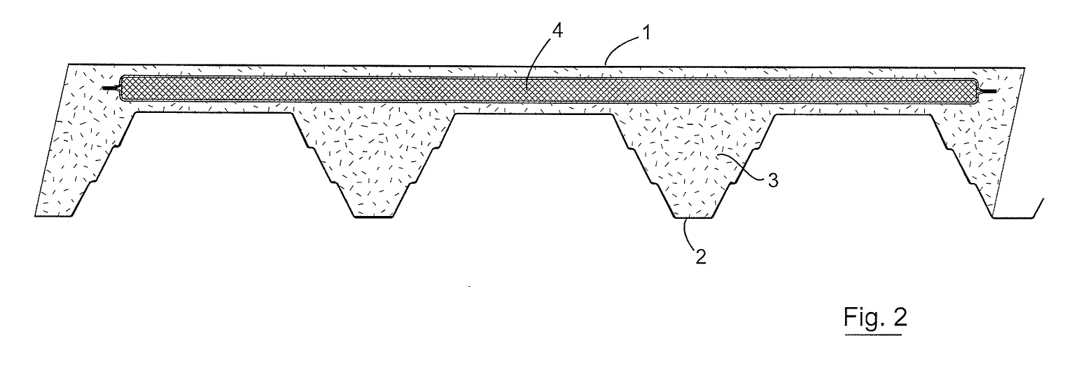

FIG. 3 is a cross sectional view of portions of two adjacent insulating panels of the invention;

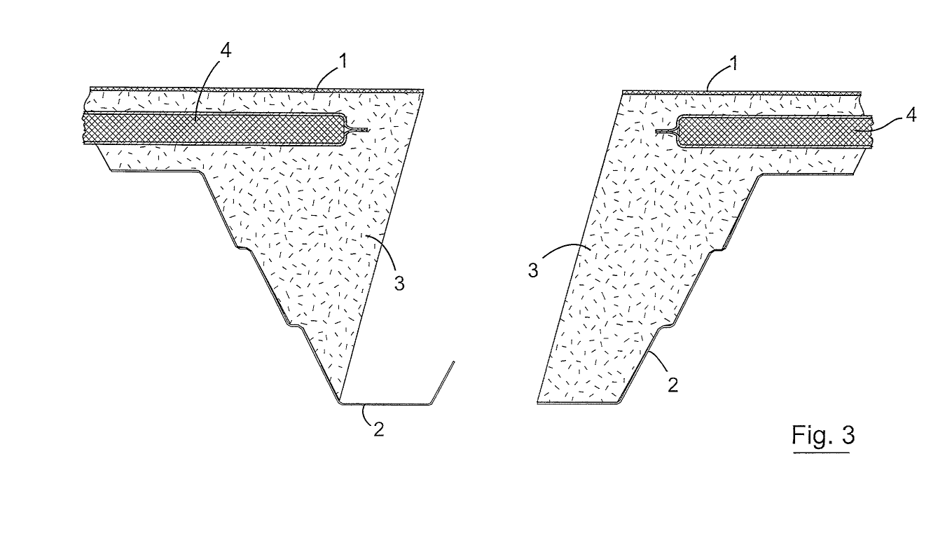

FIGS. 4(a) to 4(c) are cross sectional views illustrating portions of alternative insulating panels of the invention;

FIGS. 5(a) to 5(g) are diagrams illustrating the manufacture of a panel of the invention;

FIG. 6 is a cross sectional view of roof panel according to the invention;

FIG. 7 is a cross sectional view of a wall panel according to the invention.

FIG. 8 is a cross sectional view of a joint between two adjacent wall panels of the invention; and

FIG. 9 is a cross sectional view of another roof panel according to the invention.

### DETAILED DESCRIPTION

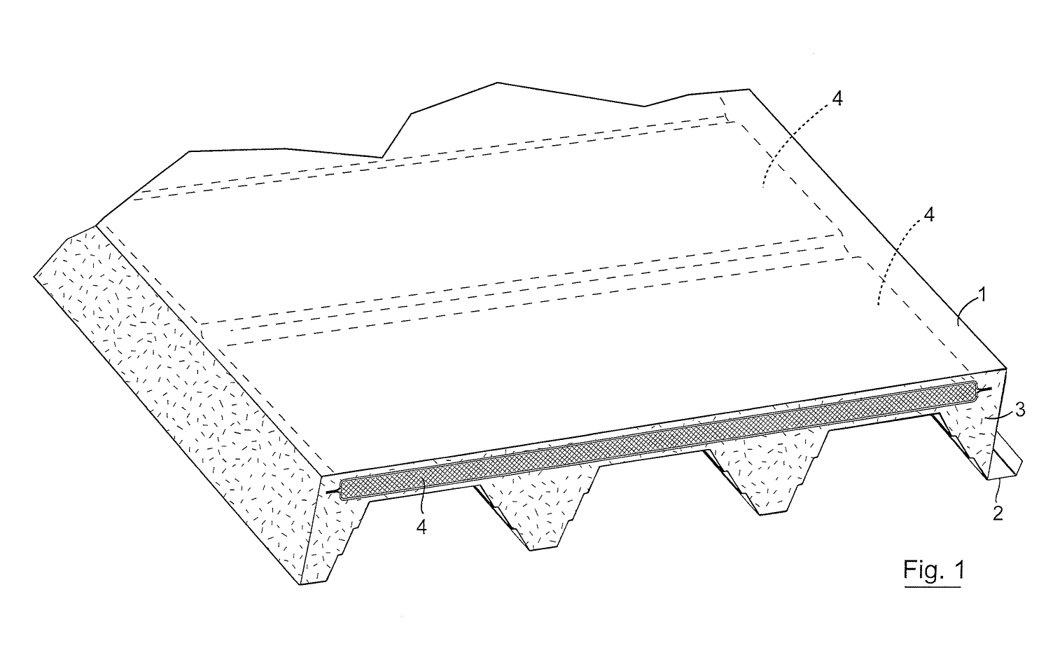

Referring to the drawings and initially to FIG. 1 thereof there is illustrated an insulating panel according to the invention which comprises an outer facing comprising an external sheet 1, an internal facing comprising a sheet or backing tray 2 with a body of insulating foam material 3 therebetween. The insulating foam may be, for example, of polyisocyanurate.

The insulating foam 3 has a number of vacuum insulated panels 4 embedded therein. The vacuum insulated panels are of the type available from NanoPore Inc. of Albuquerque, N. Mex. These vacuum insulated panels comprise silica, titania and/or carbon in a three dimensional highly branched network of primary particles of 2 to 20 nanometers in size which aggregate into large particles on the nano or micrometer scale. The pore size is from 10 to 100 nm. The powder is pressed into boards which are cut to size and typically shrink wrapped before being encased in a metallised barrier film and sealed under vacuum.

In the invention we embed such vacuum insulation panels during manufacture of the insulating panels of the invention to provide an enhanced thermal performance. The overall thickness of the panel to achieve desired insulation properties is reduced. The vacuum insulated panels may extend for at least 25%, at least 50% and possibly at least 65% of the thickness of the insulating foam.

We have found that in composite panels a vacuum insulation panel having a thickness of 10 mm can provide similar insulation properties as a 50 mm thick section of polyisocyanurate foam. Thus in composite panels substantial savings on panel thickness can be achieved with follow-on benefits of reduced transport, and lower panel weight with consequential reduction in costs of support structures. Because of reduced support structures and panel size the structure will likely have a reduced footprint.

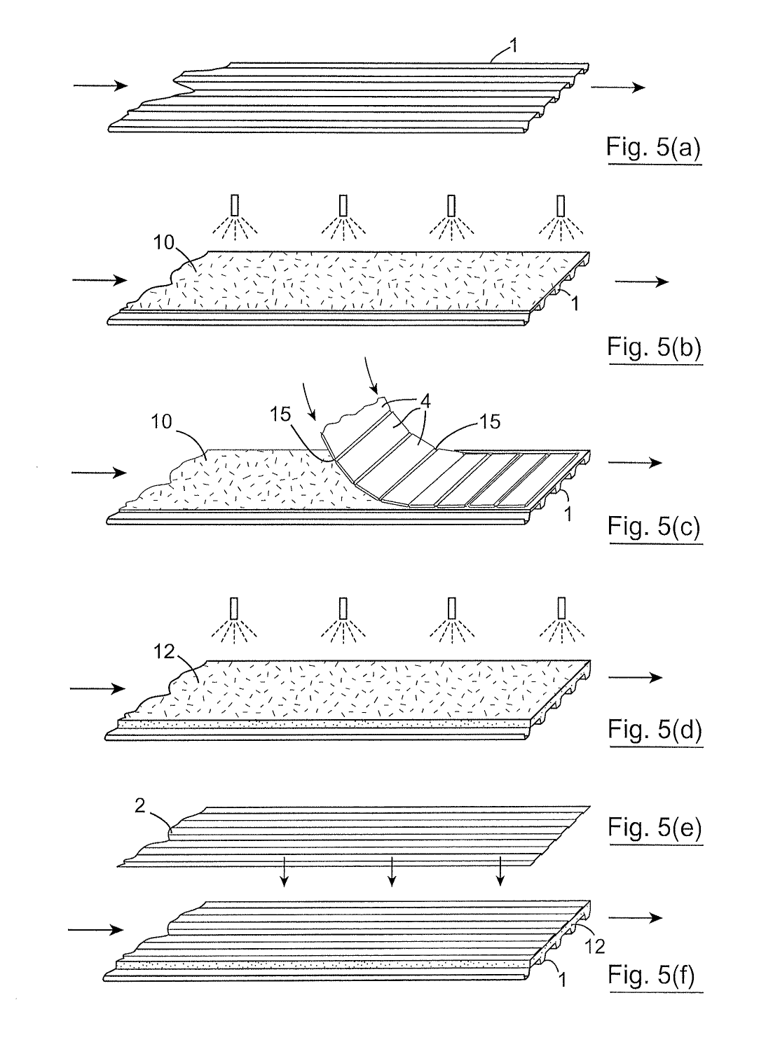

Referring to FIGS. 5(a) to 5(f) the panels of the invention are manufactured by conveying an external profiled sheet 1 along a flat bed with the outer surface of the sheet 1 lowermost. A pre-laydown 10 may be applied to the uppermost surface of the sheet 1. The vacuum panels 4 are then laid down on the pre-laydown 10 material which assists in holding them in a desired position. Liquid foam reactants 12 are then applied over the vacuum panels 4 and the sheet 2 is then led continuously over the liquid foam reactants to form an assembly. The assembly is then heated in an oven to allow the liquid foam reactants to expand to form an insulated core 3 with the vacuum panel(s) 4 embedded therein between the sheets 1, 2.

The pre-laydown may comprise liquid foam reactants and/or may comprise a compatible adhesive.

The vacuum panels 4 may be inserted manually prior to lay-down of liquid foam reactants or are preferably inserted automatically, for example as illustrated in FIG. 5(c) the vacuum panels may be provided on a reel or stack from which the vacuum panels are led.

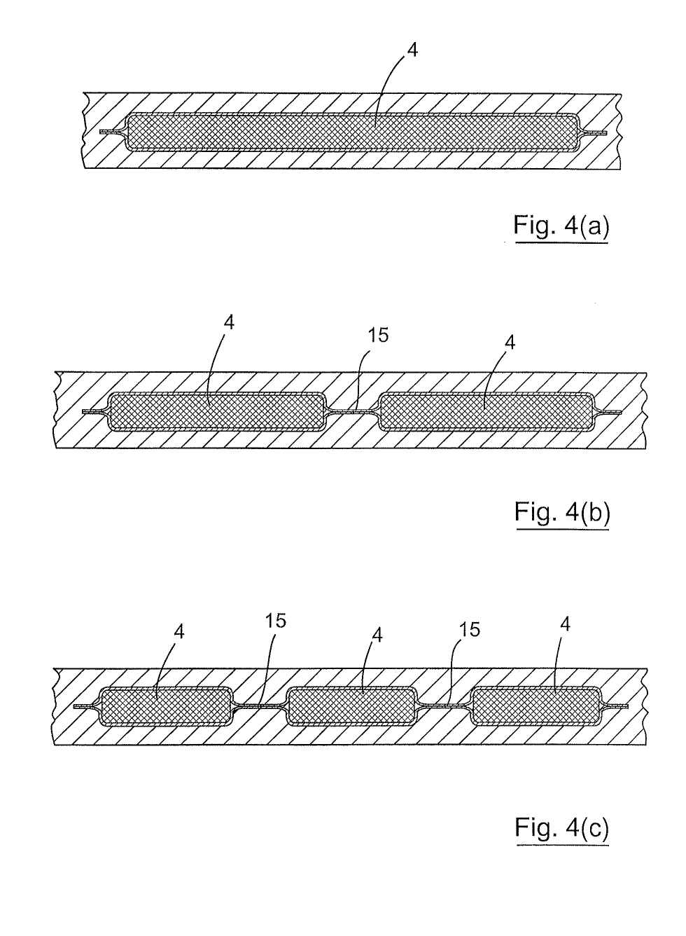

As illustrated in FIGS. 4(a) to 4(c) there may be plurality of such vacuum panels 4 across the length and/or width and the vacuum panels are preferably interconnected by a suitable webbing 15 or other interconnection to assist in storing and automatic handling of the vacuum panels 4. FIGS. 4(a) to 4(c) illustrate typical cross sections of various panels according to the invention with alternative arrangements of vacuum panels embedded therein. There may be one, two or several vacuum panels spaced-apart along or across the insulating panels of the invention.

The insulated panel 1 illustrated in FIG. 1 is a typical panel with a profile sheet 1 which may be uppermost or lowermost when the panel is in situ.

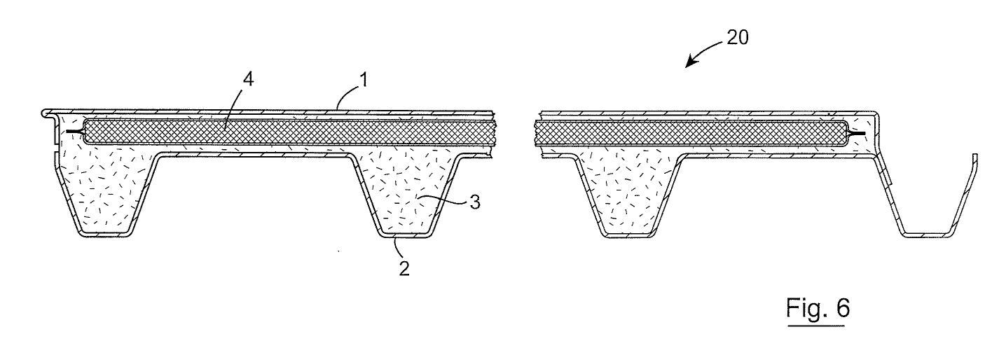

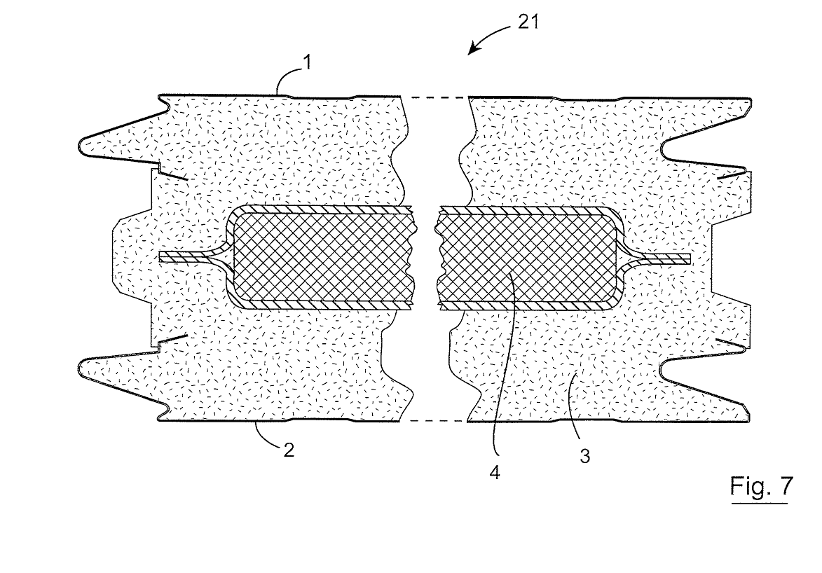

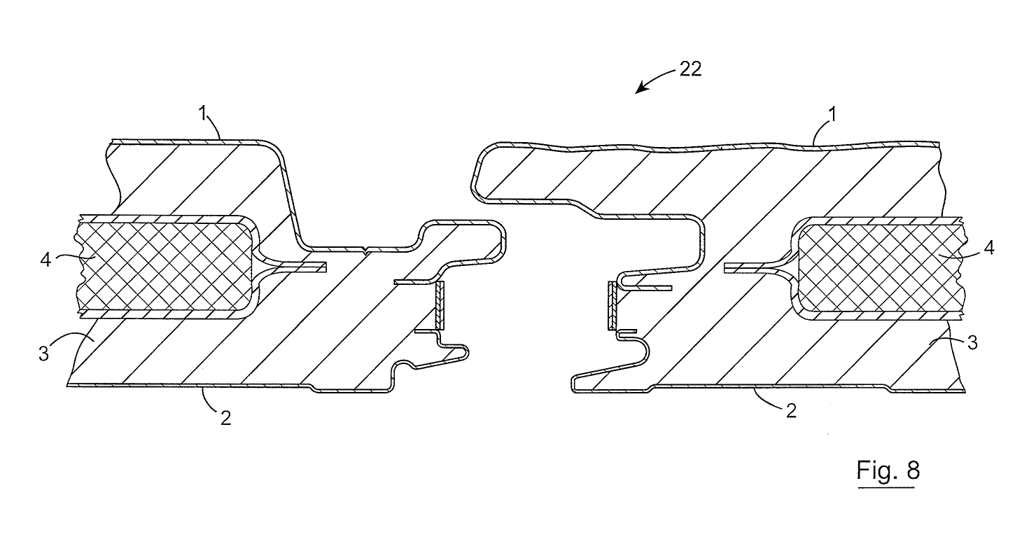

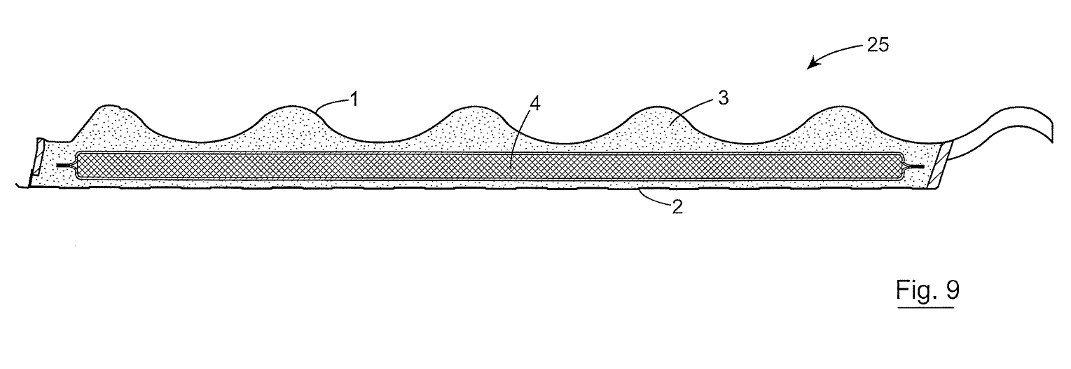

The invention may be applied to any suitable composite insulating panels, such as the typical roof panels 20 illustrated in FIG. 6 or to wall panels 21, 22 respectively illustrated in FIGS. 7 and 8 which have profiled joint forming details along the side edges thereof. Many other variations are possible. For example, the panel may be a roof panel 25 with a tile profile as illustrated in FIG. 9.

The invention is not limited to the embodiments hereinbefore described which may be varied in detail.

1-23. (canceled)

24. An insulating panel comprising an external facing, an internal facing, a single body of expanded insulating foam material extending between the facings, and a plurality of vacuum insulating panels embedded in the expanded single insulating foam body, the vacuum insulated panels being interconnected by an interconnection.

25. The panel as claimed in claim 24 wherein the vacuum insulated panels extend longitudinally substantially the length of the insulated panel.

26. The panel as claimed in claim 24 wherein the vacuum insulated panels extend laterally substantially the width of the insulating panel.

27. The panel as claimed in claim 24 wherein the vacuum insulated panels extend for at least 25% of the thickness of the insulating foam.

28. The panel as claimed in claim 24 wherein the vacuum insulated panels extend for at least 50% of the thickness of the insulating foam.

29. The panel as claimed in claim 24 wherein the vacuum insulated panels extend for at least 65% of the thickness of the insulating foam.

30. The panel as claimed in claim 24 wherein the inner facing is of metal sheet.

31. The panel as claimed in claim 24 wherein the outer facing is of metal sheet.

32. The panel as claimed in claim 30 wherein the inner sheet is profiled.

33. The panel as claimed in claim 24 wherein the interconnection comprises a webbing.

34. The panel as claimed in claim 31 wherein the outer sheet is profiled.

35. A method for manufacturing an insulating body comprising the steps of:—
leading a first substrate to a foam lay down station;
laying liquid foam reactants onto the first substrate;
applying a second substrate over the liquid foam reactants;
allowing the foam to expand to form an insulating body;
wherein before, after or during lay-down of liquid foam reactants a vacuum insulating panel is inserted.

36. A method as claimed in claim 35 wherein the vacuum insulated panel is inserted after application of a first lay down

37. A method as claimed in claim 36 wherein the first lay down comprises a bonding material which is compatible with the liquid foam reactants.

38. A method as claimed in claim 37 wherein the first lay down comprises liquid foam reactants.

39. A method as claimed in claim 35 wherein a plurality of vacuum insulating panels are inserted.

40. A method as claimed in claim 39 wherein the vacuum insulating panels are interconnected and the method comprises inserting the interconnected panels.

41. A method as claimed in claim 35 comprising the steps of providing a plurality of interconnected vacuum panels and substantially continuously inserting the vacuum panels onto the first lay-down.

42. A method as claimed in claim 41 wherein the vacuum panels are in a stack or are on a reel and the method comprises leading the vacuum panels from the stack or reel for insertion.

43. A method as claimed in claim 35 wherein the first substrate is of metal sheet.

44. A method as claimed in claim 43 wherein the first substrate is of profiled metal sheet.

45. A method as claimed in claim 35 wherein the second substrate is of metal sheet.
